(19) United States
(12) Patent Application Publication
(10) Pub. No.: US 2018/0276059 A1
(43) Pub. Date: Sep. 27, 2018

(54) PROGRAMMING LANGUAGE-INDEPENDENT TRANSACTION CORRELATION

(71) Applicant: CA, Inc., New York, NY (US)

(72) Inventors: Ales LOPATA, Brezany II (CZ); Jan PODROUZEK, V Rybnickach (CZ)

(73) Assignee: CA, Inc., New York, NY (US)

(21) Appl. No.: 15/470,361

(22) Filed: Mar. 27, 2017

(51) Int. Cl. G06F 9/54; G06F 9/445

(52) U.S. Cl. CPC G06F 9/546; G06F 9/44521

(57) ABSTRACT

A method for inserting application performance management hooks in dynamically linked system libraries in a programming language independent way includes determining a dynamically linked library called by a plurality of applications to transmit and receive messages to and from other applications, and overriding a first method, in the dynamically linked system library, used in transmitting messages to include a transaction identifier in messages transmitted by any of the plurality of applications. The method also includes overriding a second method, in the dynamically linked system library, used in receiving messages to extract the transaction identifier from any messages received by any of the plurality of applications. The method further includes determining a first application that transmitted the first message based on the identifier, determining a second application that the first message is intended for, and logging information associated with transmission and receipt of the first message for the first and second applications.

### BACKGROUND

The disclosure relates generally to transaction correlation, and specifically to programming language-independent transaction correlation.

### SUMMARY

According to one embodiment of the disclosure, a method includes determining a dynamically linked library called by a plurality of applications to transmit and receive messages to and from other applications, and overriding a first method, in the dynamically linked library, used in transmitting messages to include a transaction identifier in messages transmitted by any of the plurality of applications. The method also includes overriding a second method, in the dynamically linked library, used in receiving messages to extract the transaction identifier from any messages received by any of the plurality of applications. The method further includes, in response to receiving, by the dynamically linked library, a first message at the second method: determining a first application that transmitted the first message based on the identifier; determining a second application that the first message is intended for; and logging information associated with transmission and receipt of the first message for the first and second applications.

Other features and advantages of the present disclosure are apparent to persons of ordinary skill in the art in view of the following detailed description of the disclosure and the accompanying drawings.

### BRIEF DESCRIPTION OF THE DRAWINGS

For a more complete understanding of the configurations of the present disclosure, needs satisfied thereby, and the features and advantages thereof, reference now is made to the following description taken in connection with the accompanying drawings.

FIG. 1 illustrates a block diagram of an application performance management system with programming language-independent transaction correlation in accordance with a non-limiting embodiment of the present disclosure.

FIG. 2 illustrates a flow chart of a method for logging application performance management data with programming language-independent transaction correlation in accordance with a non-limiting embodiment of the present disclosure.

FIG. 3 illustrates process diagram of a host system in an application performance management system with programming language-independent transaction correlation in accordance with a non-limiting embodiment of the present disclosure.

FIG. 4 illustrates a system diagram of an application performance management system with programming language-independent transaction correlation in accordance with a non-limiting embodiment of the present disclosure.

### DETAILED DESCRIPTION

As will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language, such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, Assembler, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

Application performance management (APM) systems monitor and manage performance and availability of software applications. In certain instances, APM systems detect and diagnose complex application performance problems to achieve a particular goal. For example, in a cloud-based SaaS type implementation, some APM systems can ensure particular levels of service are provided for a user per service level agreements. As another example, performance management systems help triage, predict, or prevent service disruptions by tracking historical system performance data and maintaining robust records of system performance. In general, APM systems monitor several sets of performance metrics. For example, APM systems may measure system load in terms of transactions processed by an application, server, or system. As another example, APM systems can track response times required for an application to respond to a user's or another application's requests or actions. In certain implementations, computational resources, such as computing capacity or utilization, memory capacity or utilization, processing capacity or utilization, network availability or bandwidth, or other performance aspects of a computing system may also be managed. Additionally or alternatively, transaction-specific information may also be tracked, such as the time the transaction was initiated, the application assigned to handling the request, the amount of time the system takes to process the request, and other information associated with the transaction.

In certain embodiments, APM systems monitor application activities at the application layer. For example, certain application events are monitored and used as inflection points for inspecting application data. The inflection points are used to insert code or execute APM code to log information associated with application execution. For example, an APM agent executing on a host server monitors applications executing on the host for certain events and executes APM system logging code that logs any of the above mentioned system performance or transaction metrics with respect to the executing application.

In certain embodiments, APM systems may “hook” into an abstract computing machine that executes application programs, such as the Java virtual machine (JVM) or the .NET Framework common language runtime (CLR). For example, certain APM systems inspect JVM execution to determine entry points for insertion of APM inflection points. Transaction information can be logged at these inflection points. Certain systems may apply the same strategy at the application layer. In certain embodiments, application code files are inspected and modified to insert APM library calls. This modification may be done at the developer-readable code level (e.g., .java files) or at the machine-readable bytecode level after compilation of the code files. For example, bytecode instructions can be inserted in compiled bytecode to call APM libraries for instrumentation.

However, existing APM solutions have several faults. For example, certain solutions require extensive custom instrumentation coding for an application in order to add APM monitoring and instrumentation to that application. As another example, certain solutions require custom coding for each monitored application on each system throughout an organization. In many situations, heterogeneous operating systems or environments yet again complicate APM instrumentation at the application level because a custom instrumentation scheme must be identified for each application and each operating system. For example, even if a standardized instrumentation scheme for one application is created for a WINDOWS system, significant modifications are required to implement that scheme on a LINUX system. As yet another example, certain solutions are limited to tracking application specific performance without reference to any other application that initiated the request. In the highly specialized distributed computing systems of today, correlating transaction performance across applications is useful in understanding performance bottlenecks and addressing breakdowns. For example, a simple user request for data may trigger communications between several applications hosted on several different servers. In order to track information associated with that request it is useful to inspect performance data at each application to determine where any bottlenecks or potential areas for improvement exist.

In certain embodiments, a programming language-independent transaction correlation performance management system addresses some and or all of these concerns by instrumenting any libraries that are commonly called by applications using dynamic linking. For example, applications are inspected and libraries that are dynamically linked to when transmitting or receiving messages (or performing any sort of system level calls such as database transactions, encryption/decryption, memory read/write, input/output (I/O) transactions, and the like) are identified. Specifically, an APM agent hosted locally on a client system or remote APM system may monitor library calls and identify dynamically linked libraries that perform low level functions. The identified dynamically linked libraries may be stored and referenced for overriding particular functions during runtime to insert transaction information to be used in correlating transactions with APM system data.

In certain embodiments, the dynamic nature of the linking between the dynamically linked libraries identified and the higher level calling applications provides that instrumentation code may be re-used by any calling application on the system. For example, any application using a dynamic link to call the instrumented libraries will be managed using the instrumentation functions. If frequently used methods or functions in those dynamically linked libraries, then run-time execution of those reference points may be overridden to include information that identifies a particular transaction. Moreover, each application in any complex chain of application calls can be tracked by adding information to messages that reference the calling application and the transaction. Any additional APM information can be sent directly to the APM system for later correlation with that particular transaction and any associated receiving application during receipt of the message or at the termination of the transaction. For example, in the case of a message sent between applications, instrumentation code that overrides run-time execution of dynamically linked libraries can add application-specific information and transaction information to a message sent between the applications, such as in a message header. That code can also send performance data regarding run-time operations of resources on the hosting system and/or network. The modified message header may be received by another dynamically linked library that implements low level functions, such as, for example, decryption of received encrypted message data or receipt of TCP/IP or HTTP messages. The information contained in the header (i.e., the transaction information and transmitting application information) may be extracted for logging to the APM system, or otherwise used in APM system analysis. Performance information for the receiving end of the message or transaction may also be sent to the APM system. The APM system may then correlate information regarding the transaction, including performance information from the transmitting system or application, with performance information from the receiving end. For example, the system may determine a total time to consummate the transaction based on the time the transaction was initiated (from the transmitting end performance data) and the time the transaction was complete (from the receiving end performance data). Bottlenecks can be realized or inferred based on these processes. For example, if plenty of resource headroom is available on both transmitting and receiving systems, then the APM system may infer that network traffic caused a slow-down in the transaction. As another example, if CPU utilization is high on the receiving system, the receiving system resources may be identified as a slow-down in the transaction.

The programming language-independent transaction correlation system may identify messages transmitted by different components of a system using the extracted information of the messages. The system may then determine performance metrics and perform tracking functions for messages traveling through heterogeneous architectures. Specialized APM systems designed for use in a single type of architecture may not be capable of managing performance of distributed processes. In certain embodiments, a programming language-independent manner may refer to a manner of overriding dynamically linked library functions without regard to any underlying human readable code, binary code, or byte-code that implements that library. For example, a hook may be inserted during run-time execution of the dynamically linked libraries so that additional APM functionality may be executed during run-time. For example, and as described above, transaction information may be inserted or extracted from a message during run-time execution of a dynamically linked library. Transaction information and/or performance data may also be transmitted to an APM system at this time. In certain embodiments, an APM system agent executing on a client device inserts hooks in the execution and executes the instrumentation functions during execution of the dynamically linked library functions called by higher level applications. Thus, the programming language-independent manner may also be independent of the programming language of the calling applications, and, in particular embodiments, does not modify any binary or human readable code of the high level calling application or dynamically linked and called libraries to achieve the described functionality.

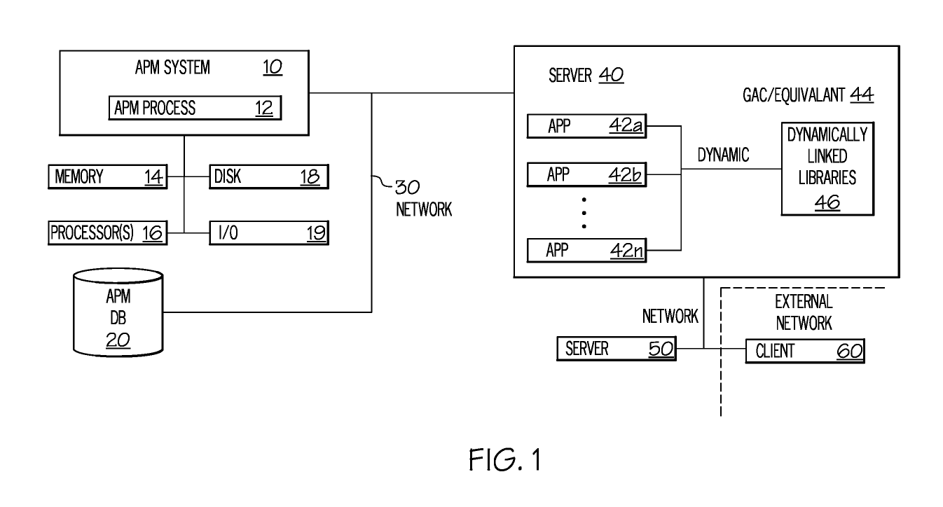

With reference to FIG. 1, a block diagram of an APM system 10 with programming language-independent transaction correlation is illustrated in accordance with a non-limiting embodiment of the present disclosure. The system includes an APM system 10 with memory 14, processor(s) 16, disk 18, and input/output (I/O) 19 that executes an APM process 12. The APM process 12 is connected by network 30 to APM database 20, server 40, and server 50. Server 40 hosts many applications 42a-n that dynamically call certain dynamically linked libraries 46. For example, these dynamically linked libraries 46 may reside in a general assembly cache (GAC) 44 or equivalent cache 44 of libraries that may be called by other applications, and may include system libraries, application libraries, encryption libraries, decryption libraries, and any other dynamically linked libraries. These dynamically linked libraries may be registered with the GAC during installation so that they may be called by other applications. The libraries may be called to perform basic low-level computing functions such as transmission and reception of messages between applications, internet communications by various protocols, encryption and decryption of data, memory read/write operations, and the like. By way of distinction, statically linked libraries may be installed or copied for exclusive use by an installed application. References to a statically linked library may be hard-coded as the known or relative installation path for the library, instead of a dynamic coding to reference a system-registered version of the library. Those of ordinary skill in the art will appreciate the differences between statically and dynamically linked libraries.

In certain embodiments, APM process 12 may monitor dynamically linked libraries 46 to determine key low level libraries that send and receive calls from one or more higher level applications. For example, operation of Applications 42a-n can be monitored to determine which low level system processes each application calls. The operative libraries may then be determined by analyzing the results of the application monitoring. In certain embodiments, APM process 12 inspects those low level libraries to determine execution points within the libraries. For example, a message transmit and receive function in a dynamically linked library may be targeted. As another example, execution points that transmit database queries are identified. The APM system can insert hooks into these execution points to insert instrumentation library calls in the application process. The instrumentation libraries may, in certain embodiments, retrieve information about the calling application and insert this information into the message in order to identify the application. For example, if application 42a calls an instrumented low level and dynamically linked library, the instrumentation library or inserted instrumentation code may retrieve a transaction identifier for application 42a. The APM system may provide transaction identifiers for all applications in one or more systems. The APM transaction identifier inserted into the message, query, or other transmission may then be used by other instrumentation functions to identify the transmitting application. For example, the APM system may coordinate messages sent between low level libraries by identifying the transmitting and receiving higher level applications and tracking performance metrics regarding those transmissions. In certain embodiments, the transaction identifier may include an application identifier that indicates the application that initiated the message transmission and/or one or more applications that are the intended recipients of the transmission.

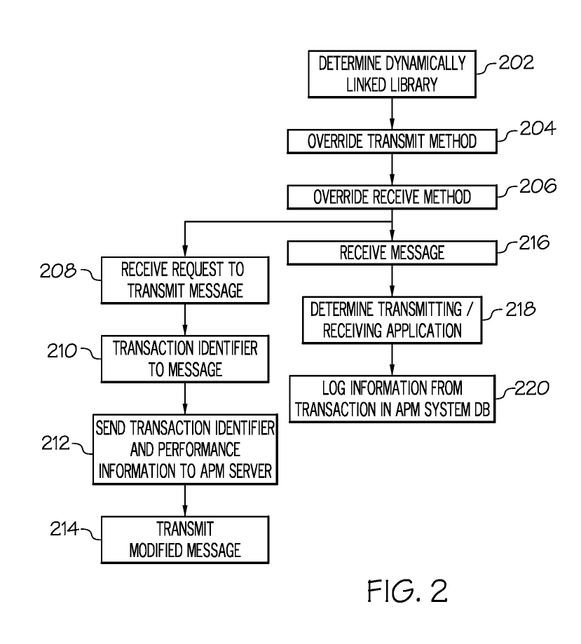

With reference to FIG. 2, a flow chart of a method for logging application performance management data with programming language-independent transaction correlation is illustrated in accordance with another non-limiting embodiment of the present disclosure. At step 202, one or more dynamically linked libraries are determined. For example, an APM system may monitor high level applications to determine low level and dynamically linked libraries that are called for executing certain functions. For example, libraries used in sending or receiving IP messages may be determined. At step 204, a transmit method within the low-level library is overridden to include instrumentation code. For example, a call to an instrumentation library may be inserted in the overridden code. As another example, instrumentation code may be inserted in the low level library itself. At step 206, a method used in receiving messages is determined in the low level library. Similarly, instrumentation code is inserted (i.e., instrumentation library calls and/or instrumentation code). Those of ordinary skill in the art will appreciate that a wide variety of low level system functionalities may be overridden to include instrumentation code, and that the present disclosure is not limited to identification of and instrumentation of transmit/receive functions of low level libraries.

At step 208, depending on the data flow, the low level system receives a request to transmit a message from a first high level application. For example, a wide variety of applications may be executing on a particular system. The low level and dynamically linked libraries may handle certain functions for each of those systems. For example, all web applications may use a particular low level library for sending and receiving HTTP or HTTPS messages. As another example, certain dynamically linked libraries are called to encrypt and/or decrypt messages. Those of ordinary skill in the art will appreciate the wide variety of low level functionality that may be implemented using a dynamically linked library. Using this example, a REST web service receives a request and transmits a response. The response includes a message payload and header information. The service relies on low level libraries to transmit the response using HTTP. Instrumentation information, including the time of the transmission, CPU and memory performance information, network utilization, and other application performance information is transmitted to the APM system independently at step 212, while the transaction identifier(s) is inserted in to the message header at step 210. In certain embodiments, information identifying the calling application is also transmitted to the APM system at step 212. The modified message is then transmitted at step 214.

In certain embodiments, additional information, such as performance information is correlated with the transaction identifying information by the APM system after the transaction is finished. For example, information regarding particular system components, such as CPU or memory capacity or the like may be correlated with the transaction by the APM system.

Considering the second data flow path, at step 216, a message is received by a low level process and routed to a higher level application. Continuing the example above, a web application receives the message transmitted by the web service containing the APM and instrumentation data. The instrumented low level process may determine the destination application based on routing information contained in the message at step 218. The message may then be logged in an APM system at step 220. The APM system can identify information about the message, including the application that transmitted the message and the time it was transmitted (e.g., from the transaction identifier inserted in the message), the destination application, the time the message was received, CPU performance data on the transmitting and receiving system, and other performance data.

Existing APM solutions that require instrumenting libraries may be targeted to specific programming languages, such as Java, .NET, etc., and may exclude low level processes such as system libraries written in low level programming languages like C or assembly. Instrumented libraries written in other languages, such as PHP, and other less popular high level languages may have high maintenance requirements, requiring manual code modifications to include instrumentation calls. In certain embodiments, an APM solution has multiple agents that execute in the monitored applications. These agents can tag outgoing (for example, HTTPS) traffic and recognize incoming tagged traffic by intercepting certain Java or .NET methods. Existing APM solutions may have no way to support all libraries in a language-independent manner.

In certain embodiments, an APM system of the present disclosure overcomes these problems by recognizing dynamically linked libraries that are called in processing low level transactions, such as transmitting and receiving messages. For example, HTTP(s) libraries, encryption libraries, database libraries, and the like may be instrumented. Application and performance monitoring information may then be appended to any and all messages processed by these identified libraries during run-time execution of the libraries by inserting hooks into those execution points. Accordingly, instrumentation of each application is not required for APM tracking of all system applications.

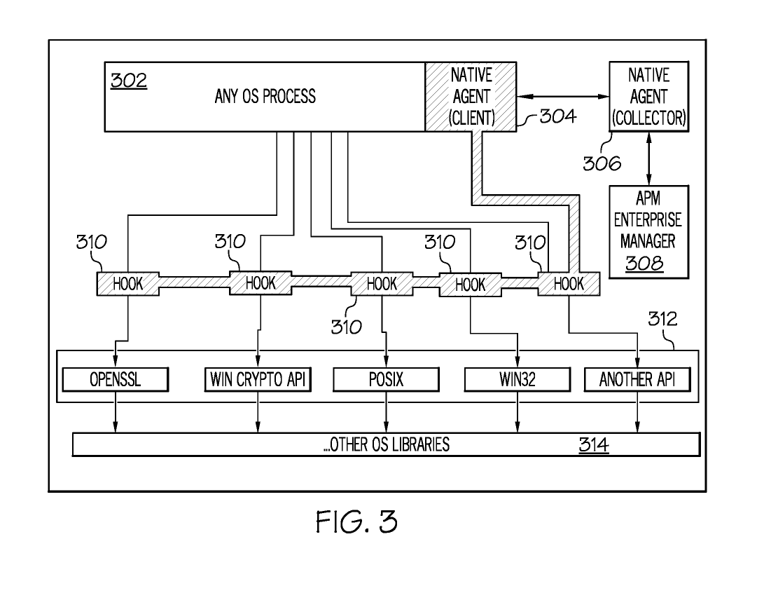

For example, with reference to FIG. 3, a native agent 304 of an APM enterprise manager 308 executing on a client host and managed by a native agent collector 306 in communication with APM Enterprise Manager 308 is illustrated in accordance with a non-limiting embodiment of the present disclosure. Native agent 304, which executes with other OS Processes 302 inserts hooks 310 into the runtime execution of various dynamically linked libraries 312 that are in communication with other libraries (not illustrated) and other OS libraries 314. The hooks 310 are insertion points in the run-time execution of the dynamically linked libraries 312. For example, the OPENSSL library (one of the dynamically linked libraries 312) is called by applications to send and receive secure messages. At various points in the run-time execution of this library, a hook 310 is inserted and the native agent 304 executes instructions. For example, the native agent 304 hook 310 may execute instrumentation code that transmits performance information regarding the host to APM enterprise manager 308. As another example, the native agent 304 hook 310 may also modify the message being transmitted or received by the OPENSSL library. For example, the message may be modified to insert or retrieve a transaction identifier from a particular portion of the message, such as the message header. The transaction identifier may then be used by the APM enterprise manager 308 to correlate performance information with specific transactions. Hooks 310 may enable this process to be implemented in a programming language-independent manner that is not dependent on any implementing programming language of the dynamically linked libraries 312 or calling application libraries.

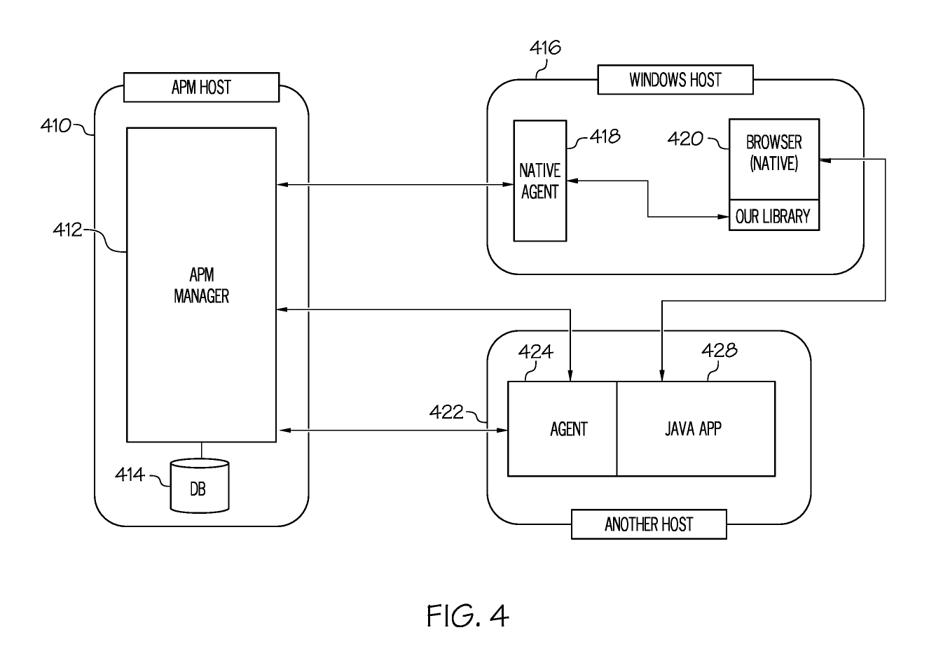

With reference to FIG. 4, a block diagram of a programming language-independent transaction correlation system is illustrated in accordance with yet another non-limiting embodiment of the present disclosure. APM host 410 executes an APM manager 412 in communication with a database 414 that application performance management data. The APM host 410 is in communication with various hosts. By way of non-limiting example, the APM manager 412 manages native agents 418 and 424 on, for example, windows host 416 and another host 422. Those of ordinary skill in the art will appreciate that windows host 416 is illustrated for purposes of an example only and that any type of operating system may be managed by APM manager 412. Native agents 424 and 418 monitor applications and processes including browser 420 and java application 428, respectively. The native agents may insert hooks in the execution of dynamically linked libraries to instrument browser 420 and java application 428 operation. For example, performance data is sent to APM manager 412 and a transaction identifier is inserted in or retrieved from messages transmitted by or received by those applications. This information can be used by APM manager 412 to correlate transactions with collected performance data in a programming language independent manner through native agents 418 and 422.

The flowchart and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method comprising:
determining a dynamically linked library called by a plurality of applications to transmit and receive messages to and from other applications;
overriding a first method, in the dynamically linked library, used in transmitting messages to include a transaction identifier in messages transmitted by any of the plurality of applications;
overriding a second method, in the dynamically linked library, used in receiving messages to extract the transaction identifier from any messages received by any of the plurality of applications; and
in response to receiving, by the dynamically linked library, a first message at the second method:
determining a first application that transmitted the first message based on the identifier;
determining a second application that the first message is intended for; and
logging information associated with transmission and receipt of the first message for the first and second applications.

2. The method of claim 1, wherein the first application is executing on another system that is not executing on a host system of the dynamically linked library.

3. The method of claim 1, further comprising:
determining that the first application uses a static link to call a first system library to transmit messages;
identifying a second system library called by the first application with a dynamic link and used to transmit messages; and
overriding a method on the second system library.

4. The method of claim 1, wherein the dynamically linked library is associated with encoding and decoding of hyper-text transfer protocol (HTTP) messages.

5. The method of claim 4, wherein overriding the first method further comprises inserting the transaction identifier in a header of the HTTP messages.

6. The method of claim 1, wherein the dynamically linked library is associated with encryption and decryption of messages, and wherein the transaction identifier is inserted in a header of the first message before the first message is encrypted.

7. The method of claim 1, further comprising:
extracting transaction correlation data for the plurality of applications from the logged information.

8. The method of claim 1, wherein determining the first application comprises accessing a database of transaction identifiers and extracting information regarding the first application from the database based on the identifier.

9. The method of claim 1, wherein the dynamically linked library is a database access layer, the first and second applications are the same application; and the first message is a database query.

10. The method of claim 1, wherein the first application is executing on a first system executing a first operating system type, and wherein the second application is executing on a second system executing a second operating system type.

11. The method of claim 1, wherein the overriding the first and second methods is performed in a programming language-independent manner by modifying the run-time execution of those methods and without modifying the binary code or human-readable code for the dynamically linked library.

12. A computer configured to access a storage device, the computer comprising:
a processor; and
a non-transitory, computer-readable storage medium storing computer-readable instructions that when executed by the processor cause the computer to perform:
determining a dynamically linked library called by a plurality of applications to transmit and receive messages to and from other applications;
overriding a first method, in the dynamically linked library, used in transmitting messages to include a transaction identifier in messages transmitted by any of the plurality of applications;
overriding a second method, in the dynamically linked library, used in receiving messages to extract the transaction identifier from any messages received by any of the plurality of applications; and
in response to receiving, by the dynamically linked library, a first message at the second method:
determining a first application that transmitted the first message based on the identifier;
determining a second application that the first message is intended for; and
logging information associated with transmission and receipt of the first message for the first and second applications.

13. The computer of claim 12, wherein the first application is executing on another system that is not executing on a host system of the dynamically linked library.

14. The computer of claim 12, further comprising:
determining that the first application uses a static link to call a first system library to transmit messages;
identifying a second system library called by the first application with a dynamic link and used to transmit messages; and
overriding a method on the second system library.

15. The computer of claim 12, wherein the dynamically linked library is associated with encoding and decoding of hyper-text transfer protocol (HTTP) messages.

16. The computer of claim 15, wherein overriding the first method further comprises inserting the transaction identifier in a header of the HTTP messages.

17. The computer of claim 12, wherein the dynamically linked library is associated with encryption and decryption of messages.

18. The computer of claim 12, further comprising:
extracting transaction correlation data for the plurality of applications from the logged information.

19. The computer of claim 12, wherein determining the first application comprises accessing a database of transaction identifiers and extracting information regarding the first application from the database based on the identifier.

20. A computer program product comprising:
a computer-readable storage medium having computer-readable program code embodied therewith, the computer-readable program code comprising:
computer-readable program code configured to determine a dynamically linked library called by a plurality of applications to transmit and receive messages to and from other applications;
computer-readable program code configured to override a first method, in the dynamically linked library, used in transmitting messages to include a transaction identifier in messages transmitted by any of the plurality of applications;
computer-readable program code configured to override a second method, in the dynamically linked library, used in receiving messages to extract the transaction identifier from any messages received by any of the plurality of applications; and
computer-readable program code configured to in response to receiving, by the dynamically linked library, a first message at the second method:
determine a first application that transmitted the first message based on the identifier;
determine a second application that the first message is intended for; and
log information associated with transmission and receipt of the first message for the first and second applications.
